(19) United States
(12) Patent Application Publication
(10) Pub. No.: US 2023/0334514 A1
(43) Pub. Date: Oct. 19, 2023

(54) ESTIMATING AND PROMOTING FUTURE USER ENGAGEMENT OF APPLICATIONS

(71) Applicant: Microsoft Technology Licensing, LLC, Redmond, WA (US)

(72) Inventors: Javier HERNANDEZ RIVERA, Somerville, MA (US); Mar GONZALEZ FRANCO, Seattle, WA (US); Melanie J. KNEISEL, Seattle, WA (US); Adam B. GLASS, Woodinville, WA (US); Jarnail CHUDGE, Reading (GB); Tiffany LIU, San Ramon, CA (US); Antonella MASELLI, Terni (IT); Amos MILLER, Seattle, WA (US)

(73) Assignee: Microsoft Technology Licensing, LLC, Redmond, WA (US)

(21) Appl. No.: 17/723,182

(22) Filed: Apr. 18, 2022

(51) Int. Cl. G06Q 30/02

(52) U.S. Cl. CPC G06Q 30/0202

(57) ABSTRACT

Aspects of the present disclosure relate to generating an engagement model to predict actions that may have a high probability of maintaining user engagement in-application or causing a user to reengage with the application. To generate the engagement model, an approach has been developed which incorporates features analysis of the application and application users. Users may be grouped based on similar features that are used to generate machine learning engagement models. The output of an engagement model may be a prediction on whether a user will continue to engage with an application. The prediction may be provided to a reengagement model which may output prompts to help increase user engagement with the application. The prompts may be based on an understanding of application users and their preferences.

### BACKGROUND

Applications have become a common way for individuals to interact with other people and businesses in the modern world. Application developers attempt to design applications with the greatest utility and ease of use to increase popularity of the application, number of application users and overall user engagement with the application. However, maintaining user engagement over time is a challenging problem because it is not easy to understand what actions should be taken to incentivize a user and maximize engagement. Without a clear understanding of application users, actions taken to increase engagement may be unsuccessful or worse have the opposite effect of dissuading users from interacting with the application.

It is with respect to these and other general considerations that aspects of the present disclosure have been described. Also, although relatively specific problems have been discussed, it should be understood that the examples disclosed herein should not be limited to solving the specific problems identified in the background.

### SUMMARY

Aspects of the present disclosure relate to generating an engagement model to predict actions that may have a high probability of maintaining user engagement in-application or causing a user to reengage with the application. To generate the engagement model, an approach has been developed which incorporates features analysis of the application and application users. Users may be grouped based on similar features that are used to generate machine learning the engagement models. The output of an engagement model may be a prediction on whether a user will continue to engage with an application. The prediction may be provided to a reengagement model which may output prompts to help increase user engagement with the application. The prompts may be based on an understanding of application users and their preferences. Thus, the engagement model and reengagement model, according to the aspects described herein, may enable better understanding of application users, allow for personalization of certain application experiences and promote long-term application user engagement.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a diagram illustrating a system for generating and utilizing a trained engagement model and reengagement model.

FIG. 2 is a block diagram illustrating a method for generating a trained engagement model.

FIG. 3 is a block diagram illustrating a method for utilizing a trained engagement model to provide a prediction to a reengagement model.

FIG. 4 is a block diagram illustrating a method for utilizing a reengagement model to prompt a user to remain engaged in the application.

FIG. 5 is a block diagram illustrating a method for utilizing a reengagement model to prompt a user to reengage in the application.

FIG. 6 is a block diagram illustrating example physical components of a computing device with which aspects of the disclosure may be practiced.

FIG. 7 are simplified block diagrams of a mobile computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, an application may be developed and made available to users for some purpose. Application developers attempt to design the application to be both useful and engaging to the user. Increasing user engagement is a common goal for application developers. However, prior works on application engagement are focused on scoring the current engagement and logging the history of engagement. Only after the user has disengaged with the application does the current approach attempt to reengage the user. This approach limits the available actions to only reengagement actions directed to users as a whole rather than at specific users or user groups. As a result, efforts to reengage users may be ineffective because they are not targeted at the user directly and they may come at a point in time that is too far removed from the initial engagement period to be attractive to the user.

Accordingly, aspects of the present disclosure relate to using machine learning techniques to recognize user engagement patterns and predict actions which have a high probability of maintaining user engagement while the user is still in-application or to reengage the user with the application if the user has stopped using the application. To improve user engagement with the application it is helpful to gain a better understanding of application users and attempt to model their behavior and take action(s) to reengage the user before they disengage with the application. By determining features associated with the application and users of the application it may be possible to categorize users into one or more user groups based on similar features of the users and/or similar application usage. Categorizing users into user groups may provide the benefit of recognizing patterns within the high-dimensional application usage and application settings feature data. This high dimensional feature data may be utilized to generate low-dimensional feature vectors for the user groups which encapsulate the patterns into actionable model inputs. The feature vector may be provided to a machine learning engagement model for the user groups. Machine learning may be utilized to train the engagement model to generate high probability predictions for engaging the users in the user groups. The predictions may be provided to a reengagement model which may generate prompts based on the prediction and send them to the user. Machine learning may be utilized to train the reengagement model based on user response to the prompts. As the prompts are based on predictions targeted at a specific user and user group, they may have a higher probability of generating user engagement.

Forecasting users' future engagement with the application to generate actionable prompts may provide several exemplary benefits. First, it can preemptively identify users likely to stop using the application either for a short period of time or permanently. Second, it can enable the use of more personalized prompts that are tailored toward individual users based on their usage patterns and/or preferences. Third, engagement modeling can quantify the potential success and impact of future feature releases and application changes that may impact engagement patterns. Fourth, it can inform the creation of new features that promote greater engagement such as, for example, tutorials that better show the capabilities of the application in actual usage settings, promote personalized settings and feature options for particular users, etc.

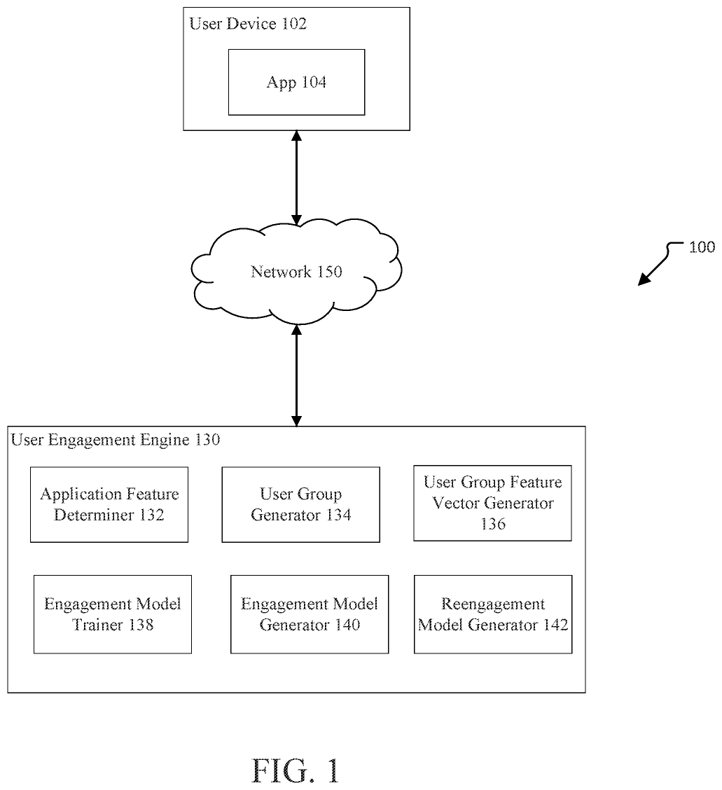

FIG. 1 illustrates an overview of a system for generating and utilizing a trained engagement model and reengagement model, according to aspects described herein. As illustrated, system 100 comprises a user device 102, application 104, user engagement engine 130 and network 150. In examples, user device 102 and user engagement engine 130 communicate via network 150, which may comprise a local area network, a wireless network, or the Internet, or any combination thereof, among other examples.

User device 102 may be any device that can receive, process, modify and communicate content on the network 150. Examples of a user device include desktop computers, laptop computers, servers, tablets and wireless devices. In examples, the application 104 is an application on the user device 102 which displays content for use on the user device 102 and for communication across the network 150. Application 104 may be a native application or a web-based application. Application 104 may operate substantially locally to computing device 102 or may operate according to a server/client paradigm in conjunction with one or more servers (not pictured). Application 104 may have permissions which allow user interaction in the application, in-application prompts from the application and out of application prompts from the application.

User engagement engine 130 may access the application via the network 150. The user engagement engine 130 may generate an engagement model to categorize user behavior and then generate prompts to initiate user behavior through the application. User engagement engine 130 is illustrated as comprising application feature determiner 132, user group generator 134, user group feature vector generator 136, engagement model trainer 138, engagement model generator 140 and reengagement model generator 142.

In examples, the application feature determiner 132 receives feature information about the application via the network 150. The information the application feature determiner 132 receives is the myriad of information about both the application and the users of the application. In its broadest sense, a feature is information that can be gathered from an application about the application itself or about a user of users of the application. For example, application features may include application functionality, application statistics, the type(s) of data collected or generated by the application, application communication features, user interface features, etc. From this broad concept it should be understood that there are a multitude of feature information that can be gathered from an application based on the type of application. For this reason, relevant application features may vary widely from one application to another. For example, a navigation application would not necessarily have the same feature information as a retail application for home sales, even though certain features may overlap between the two such as both applications may include a map feature to visualize a geographic location. Feature information may be grouped into at least two categories, general application features and specific user features.

General application features relate to commonalities offered to and experienced by all users of the application. Examples of general application features include application settings, application interfaces, accessibility features, search functionality, available application actions (e.g., content type, options to upload/download data or content, user options to interact with the application, tutorials on application options, etc.), different user account types with variable in-application user actions (e.g., member, non-member, etc.), external engagement options and in-application monetary options (application store features, offer for sale, offer for purchase, linked payment methods, etc.). It should be appreciated that this list is not exhaustive and that general application features include the variety of features which varies based on the type of application.

Specific user features relate to the methods by which a user experiences an application and may choose to engage with the application. User feature data may be collected upon receiving permission from the user to collect such data. Specific user features may involve both in-application engagement and out of application re-engagement. The user's preferences, selections, activity and engagement with the application are the information that provides useful features for collection by the application feature determiner 132. There is a myriad of specific user features which could be collected based on the type of application. Example categories of specific user features may include: temporal features which relate to temporal aspects of application usage (e.g., day vs. night, weekday vs. weekend, amount of time engaged in-application, amount of time away from application, etc.); location features which capture the location of the user when in-application and based on privacy settings may also capture location information when out of application; demographic features which captures demographic information about the user (e.g. location information, race, ethnicity, disability status, personal characteristics such as height, weight, language setting, etc.), user device settings which provide information about the application access modes (e.g., phone vs. tablet, type of audio inputs, location tracking enablement, notification preferences, selected layers on an application, unit preferences, language preferences, time preferences, etc.); screen engagement which captures user engagement with different screens and content of the application (e.g., help screen, settings screen, home screen, feeds, etc.); first user experience captures users in-application behaviors during their first time using the application (e.g., number of seconds spent in the application during the first use, whether the user completed any tutorials, what settings were initially selected, what content was accessed, how the application was used, etc.); subsequent user experience captures user in-application behaviors during application usage subsequent to the first use (e.g., amount of time between each in-application use, changes in settings, where user engagement is focused as experience with the application is developed, etc.); tutorial engagement captures the user's engagement with application tutorials as well as subsequent user behavior and application or disregard of the tutorial; search activity details user engagement with the application's search functionality and search history; application state logs the number of events for which the application is in an active state, background state, or inactive state, retention features records user retention information based on application usage (e.g., frequency of use, consistency of use, etc.); and external engagement which captures how the user engages with application generated content outside the application (e.g., sharing content to other application users, sharing application generated content with non-application users with link to the application, sharing application generated content to a different application for display privately or publicly, etc.). The above examples of specific user feature categories across applications are not an exhaustive list and it should be understood that the specific user features of a certain application may vary and the type of user specific feature data is subject to user permission to collect said data.

As an example of application features, if the application is a navigation application for visually impaired people, additional specific user feature categories may include beacon activity which captures the number, type, and context of destination beacons that a user navigates to, button engagement which captures user engagement with buttons on the application and/or a conversational user interface that allows the user to set a desired destination using voice commands as well as hear the current location, directions along the route, nearby landmarks and other points of interest. In another instance, if the application is a music application, additional specific user feature categories may include method of content access which captures how a user accesses music (e.g., user made playlists, application specific radio channels, artist homepages, etc.) musical preferences which captures the type and style of music that a user listens to and/or additional temporal aspects which capture how a user engages with the content such as what type of music a user listens to based on time of day, day of the week and/or location.

After application features are determined, the user group generator 134 may utilize the feature information to generate user groups based on relevant features shared by multiple users and/or based upon similarities between the users themselves (e.g., users in a similar location, sharing similar demographics, etc.). A user group is a categorization of users that share similar features which can be harnessed to generate an engagement model specific to the user group. The number of groups that the user group generator 134 generates may be variable based on model design preferences. In instances, there may be a single group of all application users, multiple groups of many users with similar features within each group, smaller groups with only a few users and/or a group based on a single user. The characterization of user groups may be based on the similarities between features among users. As such the similarities between users may be based along the same or similar feature categories and feature information, such as the general application features and specific user features, described above. The characterization of users based on similarity may focus on individual features, multiple features from different categories and/or whole category features. For example, groups may be characterized by similarities in device settings such as darker or lighter system colors, notification settings, speaking options, network connectivity and privacy settings. In other examples, the demographic information of users in association with application usage patterns might generate a user group. In other instances, device settings may be disregarded in favor of focusing on users who use the application similarly to generate groups based on high engagement and low engagement.

To generate the user groups, the user group generator 134 may assign a similarity score to users of the application. The similarity score may be a measure of feature similarity between users within a group as well as with users outside the group. The more features users have in common with each other the higher the similarity score for the group. The less features users have in common with each other and the lower the similarity score for the group. The similarity score may be compared to a threshold value in order to generate the user group. In such instances, user groups may be generated where users with similarity scores higher than the threshold value will form a group, while users whose similarity score is below the threshold may not be added to the group. It is contemplated that some users may have similarity scores which place them in more than one group. Likewise, there may be users whose similarity score does not place them in any group. The effectiveness of the engagement model does not require complete categorization of all users, nor does it require discrete user groups. Once the user groups are generated, the user group generator may categorize individual users into user groups. The user group generator 134 may compare an individual user's features to the various feature settings that distinguish a user group. From this comparison, a similarity score may be generated for the user relative to the user group. Based on the closeness of the similarity score to the threshold the user may or may not be included within the user group. User groups may be static, or they may be continually updated to shift users between user groups or generate new user groups as more information is gathered relating to usage patterns, activity habits, existing users leaving the application, new users initiating engagement with the application, feature selection, etc. New users to the application may be assessed by the user group generator 134 and placed into a user group matching their feature selection and similarity scores. The more refined a group becomes the more useful the model may become as the similarity scores across users increases with the resulting probability of future engagement likewise increasing.

The user group feature vector generator 136, processes the user groups to generate a feature vector which may be used to maintain in-application user engagement or reinitiate user engagement with the application. The user group feature vector generator may utilize machine learning to model how users within the user group interact with the application throughout the engagement cycle. The engagement cycle is the collection of user actions and signals which indicate the user will remain actively engaged with the application, may remain in the application but not actively engaged with the application, may be preparing to depart from the application and/or has departed from the application with an expected period until return. In aspects, the feature vector resolves the high dimensionality of collected feature information, the engagement cycle, user activity and user groups into a low dimensional vector that can be utilized to model user engagement and predict user reengagement action. The feature vector encompasses a variety of user activity states which include when the user engages, what does a typical remain or use of the application consist of and what signals indicate a user is preparing to depart from the application and/or reengage with the application. The features utilized during the various activity periods signal user activity behavior patterns for the model to generate the feature vector for the user group. For example, if the application is a navigation application where the user regularly types in the search bar to search for restaurants at lunch time this is a signal of feature interaction that could generate a pattern within the model.

In instances, the feature vector generator 136 may incorporate a time period in modeling user behavior. The time period may be an important indicator in the model because it functions to set limits on the analysis as well as focusing the design model to judge user activity conformity within a desired initial engagement, activity, departure and return cycle. The time period may vary based on the type of application as well as the design choices of the feature vector and model. For example, in a navigation application the time period may be activity patterns within one week. For a meal service application, the time period could be three days. A social media application might have a time period of only two hours from engagement to departure to reengagement. In an instance, the time period where the initial engagement, subsequent activity, departure and reengagement offers insight into where the most important feature signals are present. The time period may also be utilized to determine the break points within the larger engagement cycle. In these instances, a time period may be applied to measure time from application departure to application reengagement as a threshold value or as a total time period from initial engagement to departure to identify common user activity patterns as well as users who exceed them to the upper and lower bounds. By identifying these signals, replicating them over time, and codifying them into a low dimensional feature vector in combination with collected features as described above, useful insights into user activity are provided which may form the basis for the engagement model.

For example, if the application is a navigation application the model may recognize that the user is newly engaged in the application by initiating a new route to a destination. The signals would likely indicate that the user will remain actively engaged with the application while transiting the route. Likewise, while transiting the route the user is intermittently actively engaged with the application, possibly to verify route directions, while also leaving the route active but not engaging with it between route waypoints. As the user approaches the destination the model may recognize that the user is near the destination and would be preparing to exist the application. Upon reaching the destination and exiting the application, based on the time period selected, the amount of time to reengagement may also be recorded. An action within the example is a potential signal that can be modeled to generate the feature vector. In the example, the signals are resulting vector are based off relatively simple features on typical user engagement patterns and do not necessarily rely on more complex features as described above. However, more complex models can be created that rely on a multitude of features to define the vector. Thus, the feature vector may function as a representation of anticipated user action to initiate application engagement, actively engage in-application, remain in-application, exit the application and/or return to the application based on the high dimensional features and user group modeling as described.

From these actions within the engagement cycle patterns may develop within user groups that will generate low dimensional vectors to model user activity and behavior. Feature vectors may be generated based upon the multitude of features and activities collected that determine user behavior. The feature vectors may be used to determine opportunities in which a user could be prompted to maintain engagement or reengage with the application. In examples, the model may highlight a certain number of features with high similarity across users within the user group as feature vectors to be utilized within the model. The feature vectors may grant insight into why a user is active in-application as well as when a user is active in the application.

The engagement model trainer 138 trains the engagement model by utilizing supervised or unsupervised machine learning. The feature vector, user groups, features, prompt outcomes and the engagement cycle may be utilized as inputs to the engagement model trainer 138. The engagement model output may be focused on predictions for maintaining user engagement with the application and, if the user has discontinued use of the application, to reengage the user with the application. Based on this instance the formalized task may be classified as a problem where given a set of engagement features from a user or user group over a certain time period the model studies and trains user engagement patterns and return to the application. In instances, the final dataset may be a classification of engaged users who maintain engagement within the defined time period, either by remaining engaged or reengaging, contrasted with disengaged users who do not meet the engagement criteria. In some instances, especially as the trained model becomes more effective at prompting engagement, an imbalanced output may be generated with significantly more users from a user group in one of the classifications.

In instances, various learning algorithms may be used in training including Support Vector Machines, Random Forests, K-Nearest Neighbor, Naïve-Bayes and/or Hidden Markov Models. To analyze engagement features the engagement model trainer 138 may utilize a variety of boosting methods in training including Random Forest, Gradient Boosting, XGBoost, Support Vector Machines and/or Adaptive Boosting (AdaBoost). To evaluate model performance multiple evaluation metrics may be applied including a confusion matrix, area under the curve, ZeroR, random rate classifier, precision, recall, weighted F1 score, specificity, receiver operating characteristics curve, recall versus receiver operating characteristics curve and accuracy. The methods listed above are not exhaustive and other methods may be utilized. To account for the potentially imbalanced dataset the weights of certain features or inputs to the model may be shifted. The weights could be shifted in a binary method or in a more variable method where weighting is done on a continuum. For example, optimizing the weighted F1 score may be applied during hyper-parameter tuning. Additionally, the model may be compared against baseline classifiers such as Random (a classifier that provides random predictions) or Most Frequent (a classifier that predicts the most frequent class). The trained model may provide at least two insights into the user groups and their engagement patterns. First, it may provide insight into how users utilize the application via the engagement cycle signals. Second, it may facilitate the model to generate predictions which may be useful to maintain in-application engagement or reengage a user on the application.

The engagement model generator 140, generates the engagement model which may be used to generate predictions of how to maintain user engagement in-application or to reengage the user with the application. An engagement model is a model which may be trained to output prompts with a high probability of either maintaining user engagement and/or initiating user engagement with the application for users within a user group. The generated engagement model may be directed towards leveraging the machine learning and repeated training cycles to estimate future user engagement predictions. There may be a single model for an application or there may be multiple models generated for various users of the application. In instances, the generated models may closely align with user groups or be targeted towards a specific user. As user groups are updated and new users initiate application engagement, the user group generator 134 and engagement model generator 140 may be updated to include the new user into an applicable user group as well as an applicable engagement model. The engagement model may be static or may be continually updated to generate new engagement models as more information is gathered relating to usage patterns, activity habits, existing users leaving the application, new users initiating engagement with the application, feature selection, etc. New users to the application may be assessed by the engagement model generator 140 and assigned an engagement model matching their feature selection, user group and similarity scores, etc.

The reengagement model generator 142, determines which prompts will be most likely to maintain user engagement or reengage a user. The reengagement model generator 142 may be utilized to target a specific user or may be targeted at a user group as defined above. The reengagement model may receive the prediction from the engagement model and may utilize the prediction to identify signals which enable proactive action in the form of prompts to alter user behavior and achieve a positive outcome. Prompts output from the reengagement model may be predicted actions which have a high likelihood of a maintaining user engagement in-application or to reengage the user in-application. Possible prompts encompass the full range of actions available in the application such as a feature, notifications and other actions that will engage a user based on the where in the engagement cycle the targeted user is. Alternatively, the engagement model generator 140 may be utilized to send output predictions and transmit prompts directly to the user without the reengagement model.

The reengagement model generator 142 transmits instructions to generate a prompt to the application 104 on the user device 102 via the network 150. Prompts may be offered to the user in-application if the user is actively using the application, as a notification in-application or as a pop-up display box on the display of their device if the application is active but in a background state on the device. If the application is inactive the user may receive the prompt via notifications on the user device if notifications are enabled and/or via other means if the sufficient permissions and user information exists (e.g., email, notifications, text messages, traditional mail, etc.). In instances, the prompt may include a link, button, tag and/or other selectable option to facilitate the user choosing to engage with the prompt. In some instances, the prompt may include a button, tag and/or other selectable option to ignore, deny or disregard the prompt.

The user action following the prompt is recorded as an outcome and returned from the application 104 to the user engagement engine 130 via the network 150. The outcome may be returned to the user engagement engine 130 immediately, at a regular update interval and/or later when application updates are delivered and log data is returned to the application developer. Any period of user engagement following a prompt and/or selection of any offered link, button, tag and/or other selectable option is a positive outcome for the prompt. No user engagement following a prompt and/or selection of a button, tag and/or other selectable option to ignore, deny or disregard the prompt is a negative outcome. Both positive and negative outcomes may be utilized to train the reengagement model and improve the prompts. Over time the reengagement model may give more weight to prompts that achieve positive outcomes regularly such that they will become regularly recommended by the reengagement model. Likewise, over time less weight in the reengagement model may be given to prompts that generate negative outcomes. Prompts with regular negative outcomes may be retried and/or eventually discarded by the reengagement model in favor of other prompt options. This outcome-based feedback loop focuses the reengagement model to be more application specific and user specific over time. This may provide the benefit of prompts being generated based on quantifiable user outcomes rather than a developer independently prompting the user based on unverified predicted user outcomes. Outcome based user feedback provides the benefit of training the reengagement model to produce prompts with validated high success rates over time.

In instances, various learning algorithms may be used in training the reengagement model including Support Vector Machines, Random Forests, K-Nearest Neighbor, Naïve-Bayes and/or Hidden Markov Models. To analyze outcomes a variety of boosting methods in training may be utilized including Random Forest, Gradient Boosting, XGBoost, Support Vector Machines and/or Adaptive Boosting (AdaBoost). To evaluate reengagement model performance multiple evaluation metrics may be applied including a confusion matrix, area under the curve, ZeroR, random rate classifier, precision, recall, weighted F1 score, specificity, receiver operating characteristics curve, recall versus receiver operating characteristics curve and accuracy. The methods listed above are not exhaustive and other methods may be utilized. To account for the potentially imbalanced dataset the weights of certain features or inputs to the model may be shifted. The weights could be shifted in a binary method or in a more variable method where weighting is done on a continuum. For example, optimizing the weighted F1 score may be applied during hyper-parameter tuning. Additionally, the reengagement model may be compared against baseline classifiers such as Random or Most Frequent. The trained reengagement model may provide insights into the user groups and their engagement patterns which may facilitate the model to generate prompts which may be useful to maintain in-application engagement or reengage a user on the application.

A prompt may encompass a wide variety of actions that may be designed to maintain engagement and to reengage a user. Examples of a prompt include offering promotional offers to a user to either keep using the application or to reengage with the application, offering certain exclusive features to a user, extending the time period of availability of a feature to a user based on engagement, offering tutorials to the user for underutilized application features among others, asking questions to the user about application features or methods of application interaction as a form of suggestion, reminding the user that an underutilized application feature is available, delivery of personalized reminders that are tailored toward specific users based on their application usage patterns, tutorials or suggestions recommending how the application may be used in conjunction with other hardware (e.g., smart wearables, headphones, other computing devices, etc.) or other applications on the device, creating new features that promote greater engagement with reminders of the updates, modifying settings or application interactivity options either generally or specifically to a user or user group to increase engagement and/or offering feature or hardware discounts in conjunction with application usage. The types of prompts available largely depends on the application type and permissions given by the user, similar to how features are determined, and user groups are categorized.

As an example of the variable nature of prompts, consider a user of a navigation application that is nearing their destination which is a movie theater. As the user approaches the destination the reengagement model generator 142 may recognize that user engagement is likely to end at the destination based on modeled signal patterns. Several prompt options are available. To maintain application engagement the user may be sent a prompt with an exclusive offer for use at the theater like discounted tickets or concession stand coupons if they complete an in-application review or other in-application action. Alternatively, the user may receive a prompt from the application asking the user's expected duration at the movie theater and offering reminders or for the application to reengage the user following the duration of time at the destination with a beneficial offering. In this case it may be an offer to navigate to a new destination or use an in-application feature to order food or ride-sharing service. The alternative prompt maintains user engagement by confirming that the user will reengage with the application at a set time. Additionally, the application could call out nearby options for activities while the user waits for the movie or for after the movie like nearby restaurants with associated promotional offers if a reservation is made or offer accessed through the application. If these prompts are ineffective, the application may periodically reengage the user with notifications to open the application and select a new route from the movie theater or to a previously offered activity at a later point in time reasonably related to the expected amount of time at the movie theater. Any positive outcome will be passed to the engagement model trainer 138 to validate the model and approach to a user and/or user group. Any negative outcome will similarly be passed to the engagement model trainer 138 to improve engagement model predictions for the specific user or user group.

As will be appreciated, the various methods, devices, applications, nodes, features, etc., described with respect to FIG. 1 or any of the figures described herein, are not intended to limit the system to being performed by the particular applications and features described. Accordingly, additional configurations may be used to practice the methods and systems herein and/or features and applications described may be excluded without departing from the methods and systems disclosed herein.

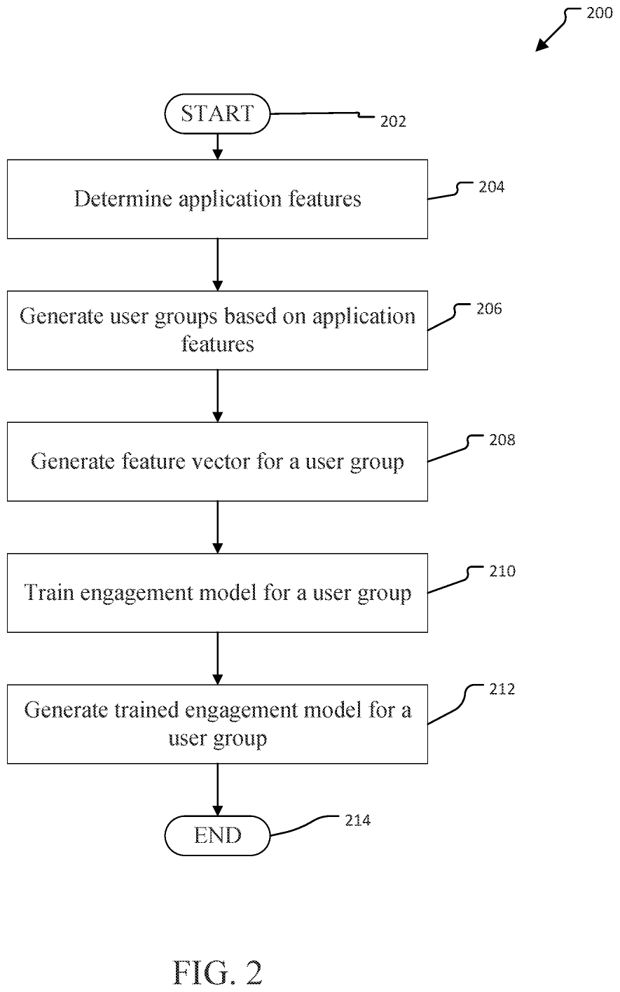

FIG. 2 is an example of a method for generating a trained engagement model. A general order of the operations for the method 200 is shown in FIG. 2. Generally, the method 200 begins with start operation 202 and ends with end operation 214. The method 200 may include more or fewer steps or may arrange the order of the steps differently than those shown in FIG. 2. The method 200 can be executed as computer-executable instructions executed by a computer system and encoded or stored on a computer readable medium. Further, the method 200 can be performed by gates or circuits associated with a processor, an ASIC, an FPGA, a SOC or other hardware device. Hereinafter, the method 200 shall be explained with reference to the systems, components, devices, modules, software, data structures, data characteristic representations, signaling diagrams, methods, etc., described in conjunction with FIGS. 1, 3, 4, 5, 6, 7 and 8.

Following the start operation 202, the method 200 begins with the determine operation 204 which determines the application features. A feature is information that can be gathered from an application about the application itself or about a user of users of the application (in accordance with user permissions). There is a multitude of feature information that can be gathered from an application based on the type of application. For this reason, relevant application features may vary widely from one application to another. Feature information may be grouped into at least two categories, general application features and specific user features. General application features relate to commonalities offered to and experienced by all users of the application. Specific user features relate to the methods by which a user experiences an application and may choose to engage with the application. Specific user features may involve both in-application engagement and out of application re-engagement. In this case the user's preferences, selections, activity and engagement with the application are the information that provides useful features for collection.

Generate operation 206 generates user groups based on the determined application features. The number of groups generated may be variable based on model design preferences. In instances, there may be a single group of all application users, multiple groups of many users with similar features within each group, smaller groups with only a few users and/or a group based on a single user. The characterization of user groups may be based on the similarities between features among users. As such the similarities between users will often be based along the same feature categories and feature information for both general application features and specific user features described above. The characterization of users based on similarity may focus on individual features, multiple features from different categories and/or whole category features.

The generate operation 208, generates a feature vector for a user group. As discussed, machine learning may be utilized to map how users within the user group interact with the application and from that interaction model the engagement cycle. The engagement cycle is the collection of user actions and signals which indicate the user will remain actively engaged with the application, may remain in the application but not actively engaged with the application, may be preparing to depart from the application and/or has departed from the application with an expected period until return. In aspects, the feature vector resolves the high dimensionality of collected feature information, the engagement cycle, user activity and user groups into a low dimensional vector that can be utilized to model user engagement and predict user reengagement action. The feature vector may include a time period which could act as a threshold value or as an analysis metric.

The training operation 210, trains the engagement model. The feature vector, user groups, features and engagement cycle may be utilized as inputs to train the engagement model. The engagement model trained output may be focused on maintaining user engagement with the application and if the user has departed the application to reengage the user with the application. For example, the formalized task may be classified as a binary problem where given a set of engagement features from a user or user group over a certain time period the model studies and trains user engagement patterns and return to the application. In instances, the final dataset may be a binary classification of engaged users who maintain engagement within the defined time period, either by remaining engaged or reengaging, contrasted with disengaged users who do not meet the engagement criteria. In some instances, especially as the trained model becomes more effective at prompting engagement, an imbalanced output may be generated with significantly more users from a user group in one of the two classifications.

The generate operation 212, generates the trained engagement model. The generated model may be directed towards leveraging the machine learning and repeated training cycles to estimate future user engagement based available prompts. There may be a single model for an application or there may be multiple models generated to for various users of the application. In instances, the generated models may closely align with user groups or be targeted towards a specific user. The generated engagement model may be used to determine whether a user or a group of users will continue engagement with the application based upon their usage patterns. The method operation ends with end operation 214.

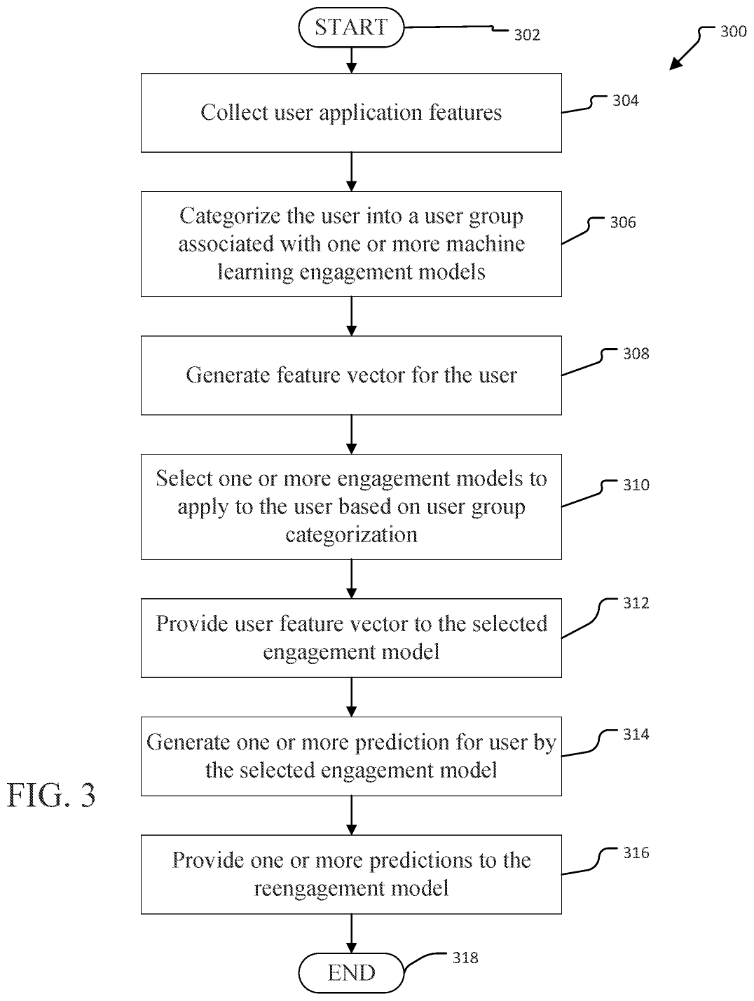

FIG. 3 is an example of a method for utilizing a trained engagement model to provide a prediction to a reengagement model. A general order of the operations for the method 300 is shown in FIG. 3. Generally, the method 300 begins with start operation 302 and ends with end operation 318. The method 300 may include more or fewer steps or may arrange the order of the steps differently than those shown in FIG. 3. The method 300 can be executed as computer-executable instructions executed by a computer system and encoded or stored on a computer readable medium. Further, the method 300 can be performed by gates or circuits associated with a processor, an ASIC, an FPGA, a SOC or other hardware device. Hereinafter, the method 300 shall be explained with reference to the systems, components, devices, modules, software, data structures, data characteristic representations, signaling diagrams, methods, etc., described in conjunction with FIGS. 1, 2, 4, 5, 6, 7 and 8.

Following the start operation 302, the method 300 begins with the collect operation, where user application features are collected. User application features may be the methods by which a specific user experiences an application and may choose to engage with the application. User application feature data may be collected upon receiving permission from the user to collect such data. User application features may involve both in-application engagement and out of application re-engagement. The user's preferences, selections, activity and engagement with the application are the information that provides useful features for collection.

Categorize operation 306, categorizes the user into a user group associated with a machine learning engagement model. The categorization may be based upon application data and/or user data collected (with user permission) at operation 304. The engagement model selected for the user may be based on a variety of inputs including user group assignment, usage patterns, activity habits, similarity score and/or feature selection, etc. The engagement model selected may also be based on the number of engagement models generated or whether a specific engagement model is intended for the user.

Generate operation 308, generates a feature vector for the user. As discussed, machine learning may be utilized to map how users within the user group interact with the application and from that interaction model the engagement cycle. The engagement cycle is the collection of user actions and signals which indicate the user will remain actively engaged with the application, may remain in the application but not actively engaged with the application, may be preparing to depart from the application and/or has departed from the application with an expected period until return. In aspects, the feature vector resolves the high dimensionality of collected feature information, the engagement cycle, user activity and user groups into a low dimensional vector that can be utilized to model user engagement and predict user reengagement action. The feature vector may include a time period which could act as a threshold value or as an analysis metric.

Select operation 310, elects one or more engagement models to apply to the user based on user group categorization. Engagement models may be directed towards users categorized in a certain user group. The engagement model selected for the user may be based on a variety of inputs including user group assignment, usage patterns, activity habits, similarity score and/or feature selection, etc. The engagement model selected may also be based on the number of engagement models generated and if more than one model may be applicable to the user.

Provide operation 312, provides the user feature vector to the selected engagement model. The feature vector provides the input to the engagement model which it may utilize to generate a prediction for the user. If more than one engagement model is selected the feature vector may be input to each engagement model. If the user is categorized into more than one user group, it may be that more than one feature vector for the user is generated. In this instance, each generated feature vector would be provided to the appropriate engagement model.

Generate operation 314, generates one more prediction for the user by the selected engagement model. The selected engagement model after receiving the feature vector may process the data and output a prediction which has a high likelihood of maintaining user engagement in-application or to reengage the user with the application. If multiple models or feature vectors are input then there may be multiple predictions output by the engagement model.

Provide operation 316, provides one or more prediction to the reengagement model. Once the engagement model outputs a prediction it may be provided to the reengagement model as the input to generate a prompt. If multiple predictions are generated by the engagement model, then the multiple predictions may be provided. The method operation ends with end operation 318.

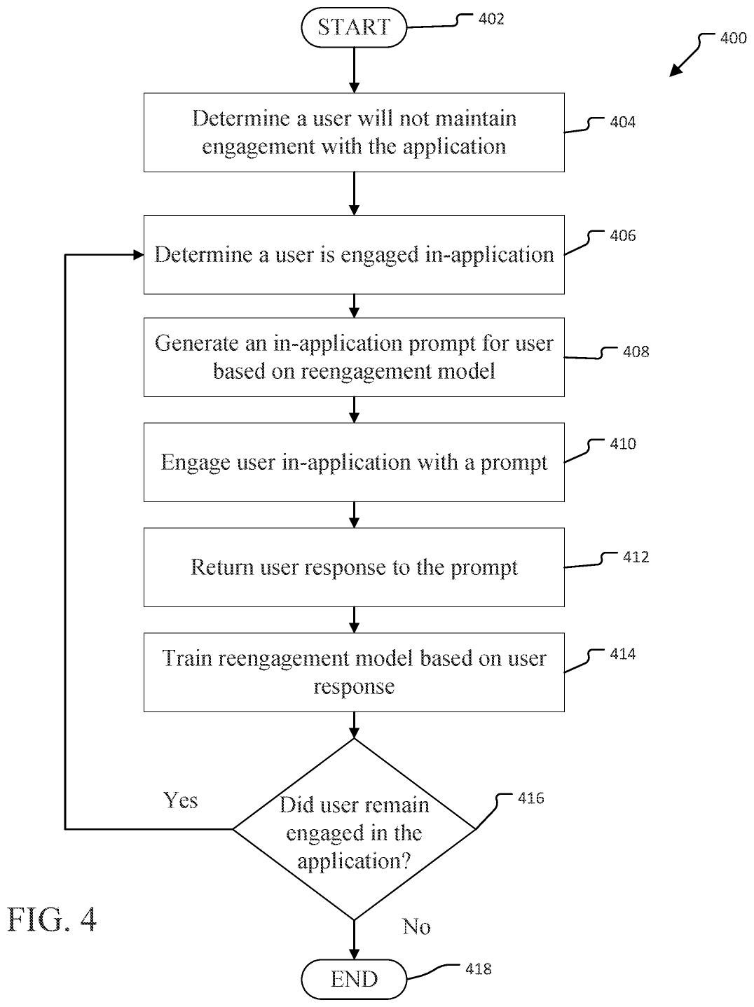

FIG. 4 is an example of a method for utilizing a reengagement model to prompt a user to remain engaged in the application. A general order of the operations for the method 400 is shown in FIG. 4. Generally, the method 400 begins with start operation 402 and ends with end operation 418. The method 400 may include more or fewer steps or may arrange the order of the steps differently than those shown in FIG. 4. The method 400 can be executed as computer-executable instructions executed by a computer system and encoded or stored on a computer readable medium. Further, the method 400 can be performed by gates or circuits associated with a processor, an ASIC, an FPGA, a SOC or other hardware device. Hereinafter, the method 400 shall be explained with reference to the systems, components, devices, modules, software, data structures, data characteristic representations, signaling diagrams, methods, etc., described in conjunction with FIGS. 1, 2, 3, 5, 6, 7 and 8.

Following the start operation 402, the method 400 begins with an operation to determine whether the user will disengage with the application. In examples, an engagement model generates a prediction of whether the user will maintain engagement with the application, for example, using the process described in FIG. 3. When the engagement model predicts that the user will not maintain engagement, reengagement actions may be taken. A categorize operation may be performed at operation 404 which categorizes the user into a user group associated with one or more machine learning engagement model. The categorization may be based upon application data and/or user data collected (with user permission) at operation 304. The engagement model selected for the user may be based on a variety of inputs including user group assignment, usage patterns, activity habits, similarity score and/or feature selection, etc. The engagement model selected may also be based on the number of engagement models generated or whether a specific engagement model is intended for the user. When the engagement model predicts the user will not maintain engagement with the application, flow continues to operation 406.

Determine operation 406, where it is determined that a user is engaged in-application. User application engagement is determined by the application based on the state of the application on the user device. The application may determine that the user is engaged if the user is either actively engaged with a feature on the application and/or if the application is open but in a background state on the device. This information may be transmitted via a network to a computer system which monitors the state of application engagement to prompt users to maintain engagement. The status update period may be variable, regular and/or specific based on the design choices of the application developer.

Generate operation 408, generates an in-application prompt for the user based on the reengagement model categorization. Prompts may be utilized to target a specific user to maintain in-application engagement. The reengagement model identifies signals which enable proactive action in the form of prompts to alter user behavior and maintain in-application engagement. Possible prompts encompass the full range of actions available in the application as a feature, notifications and other actions that may maintain user engagement.

Engage operation 410, engages the user with an in-application prompt. The selected prompt is based on the selected reengagement model output. Possible prompts encompass the full range of actions available in the application as a feature, notifications and other actions that may maintain user engagement. The user may receive the prompt as a notification in-application or as a pop-up display box on the display of their device if the application is active but in a background state on the device. In instances, the prompt may include a link, button, tag and/or other selectable option to facilitate the user choosing to engage with the prompt. In some instances, the prompt may include a button, tag and/or other selectable option to ignore, deny or disregard the prompt.

Return operation 412, returns the user response to the offered prompt. The user action following the prompt is recorded as an outcome and returned from the application to the reengagement model. The outcome may be returned immediately, at a regular update interval and/or a later time when application updates are delivered and log data is returned to the application developer. Any period of user engagement following a prompt and/or selection of any offered link, button, tag and/or other selectable option is a positive outcome for the prompt. No user engagement following a prompt and/or selection of a button, tag and/or other selectable option to ignore, deny or disregard the prompt is a negative outcome.

Train operation 414, trains the reengagement model based on the user response to the prompt. Machine learning may be utilized to train the reengagement model in either a supervised or unsupervised manner. Both positive and negative outcomes may be utilized to train the reengagement model and improve the predicted prompts output from the reengagement model. Over time more weight in the reengagement model may be given to prompts that achieve positive outcomes regularly such that they will become regularly output by the reengagement model. Likewise, over time less weight in the reengagement model may be given to prompts that generate negative outcomes. Prompts with regular negative outcomes may be retried and/or eventually discarded by the engagement model in favor of other prompt options.

Decision operation 416 determines if the user remained engaged in-application as a result of the prompt. If the user did remain engaged in-application the result is to reinitiate the method by returning to method operation 404 to await the next signal that a prompt is to be sent to maintain user engagement. If the user did not remain engaged in-application the result is to end the operation because in-application prompts will not be applicable as the user is no longer in-application. In this case the method operation ends with end operation 418.

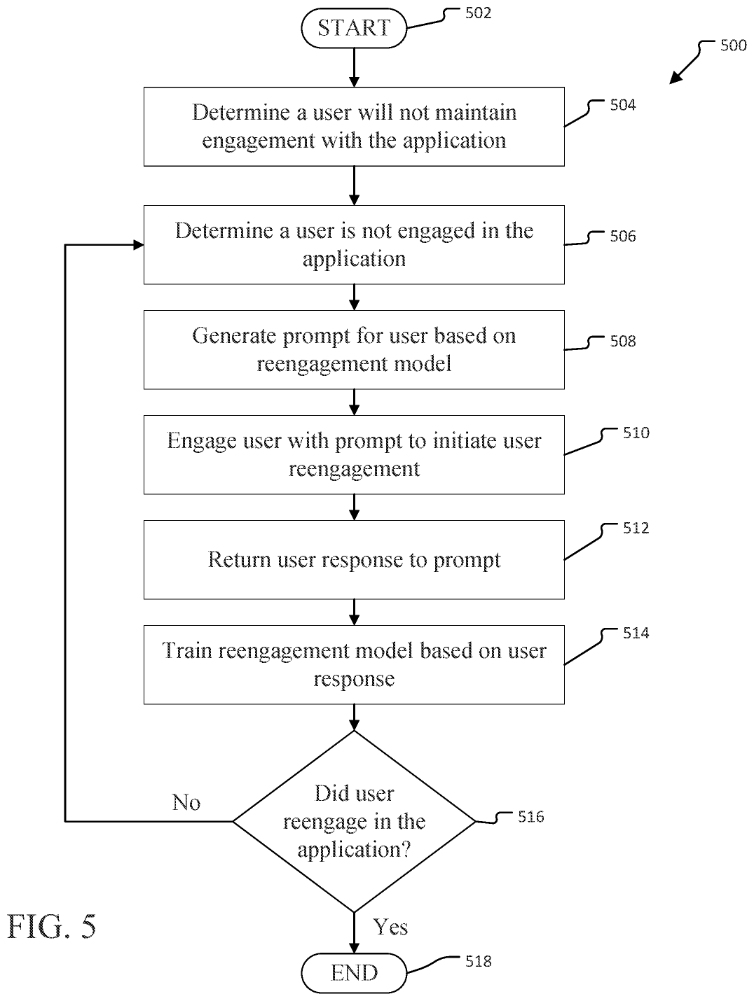

FIG. 5 is an example of a method for utilizing a reengagement model to prompt a user to reengage in the application. A general order of the operations for the method 500 is shown in FIG. 5. Generally, the method 500 begins with start operation 502 and ends with end operation 518. The method 500 may include more or fewer steps or may arrange the order of the steps differently than those shown in FIG. 5. The method 500 can be executed as computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2, 3, 5, 6, 7 and 8

Following the start operation 502, the method 500 begins with an operation 504 to determine a user will not maintain engagement with the application. In examples, an engagement model generates a prediction of whether the user will maintain engagement with the application, for example, using the process described in FIG. 3. When the engagement model predicts that the user will not maintain engagement, reengagement actions may be taken. A categorize operation may be performed at operation 306 which categorizes the user into a user group associated with one or more machine learning engagement model. The categorization may be based upon application data and/or user data collected (with user permission) at operation 304. The engagement model selected for the user may be based on a variety of inputs including user group assignment, usage patterns, activity habits, similarity score and/or feature selection, etc. The engagement model selected may also be based on the number of engagement models generated or whether a specific engagement model is intended for the user. When the engagement model predicts the user will not maintain engagement with the application, flow continues to operation 506.

Determine operation 506, determines that a user is not engaged in the application. User application engagement is determined by the application based on the state of the application on the user device. The application may determine that the user is not engaged if the application is not open and/or in a background state on the device. This information may be transmitted via a network to a computer system which monitors the state of application engagement to prompt users to maintain engagement. The status update period may be variable, regular and/or specific based on the design choices of the application developer.

Generate operation 508, generates a prompt for the user based on the reengagement model categorization. Prompts may be utilized to target a specific user to reengage with the application. The reengagement model identifies signals which enable proactive action in the form of prompts to alter user behavior and initiate application reengagement. Possible prompts encompass the full range of actions available in the application as a feature, notifications and other actions that may reengage the user.

Engage operation 510, engages the user with a prompt to initiate user reengagement. The selected prompt is based on the selected reengagement model output. Possible prompts encompass the full range of actions available in the application as a feature, notifications and other actions that may reengage the user. The user may receive the prompt via notifications on the user device if notifications are enabled and/or via other means if the sufficient permissions and user information exists (e.g., email, traditional mail, etc.). In instances, the prompt may include a link, button, tag, email, text and/or other selectable option to facilitate the user choosing to engage with the prompt. In some instances, the prompt may include a button, tag and/or other selectable option to ignore, deny or disregard the prompt.

Return operation 512, returns the user response to the offered prompt. The user action following the prompt is recorded as an outcome and returned from the application to the reengagement model. The outcome may be returned immediately, at a regular update interval and/or a later time when application updates are delivered and log data is returned to the application developer. Any period of user engagement following a prompt and/or selection of any offered link, button, tag and/or other selectable option is a positive outcome for the prompt. No user engagement following a prompt and/or selection of a button, tag and/or other selectable option to ignore, deny or disregard the prompt is a negative outcome.

Train operation 514, trains the reengagement model based on the user response to the prompt. Both positive and negative outcomes may be utilized to train the reengagement model and improve the predicted prompts output from the reengagement model. Over time more weight in the reengagement model may be given to prompts that achieve positive outcomes regularly such that they will become regularly output by the reengagement model. Likewise, over time less weight in the reengagement model may be given to prompts that generate negative outcomes. Prompts with regular negative outcomes may be retried and/or eventually discarded by the reengagement model in favor of other prompt options.

Decision operation 516, determines if the user reengaged in the application as a result of the prompt. If the user did not reengage in the application the result is to reinitiate the method by returning to method operation 5 to await the next signal that a prompt is to be sent to attempt to reengage the user. If the user did reengage in the application the result is to end the operation because in-application prompts are now applicable as the user is engaged in-application. In this case the method operation ends with end operation 518.

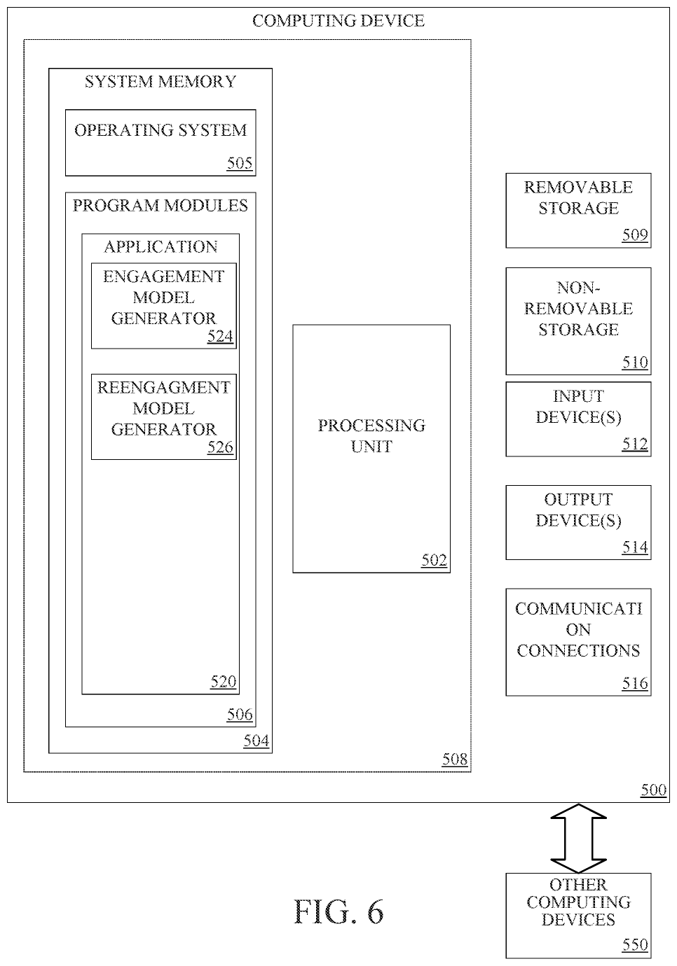

FIG. 6 is a block diagram illustrating physical components (e.g., hardware) of a computing device 600 with which aspects of the disclosure may be practiced. The computing device components described below may be suitable for the computing devices described above, including devices 104, as well as one or more devices discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store the engagement model generator 624 and reengagement model generator 626. The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

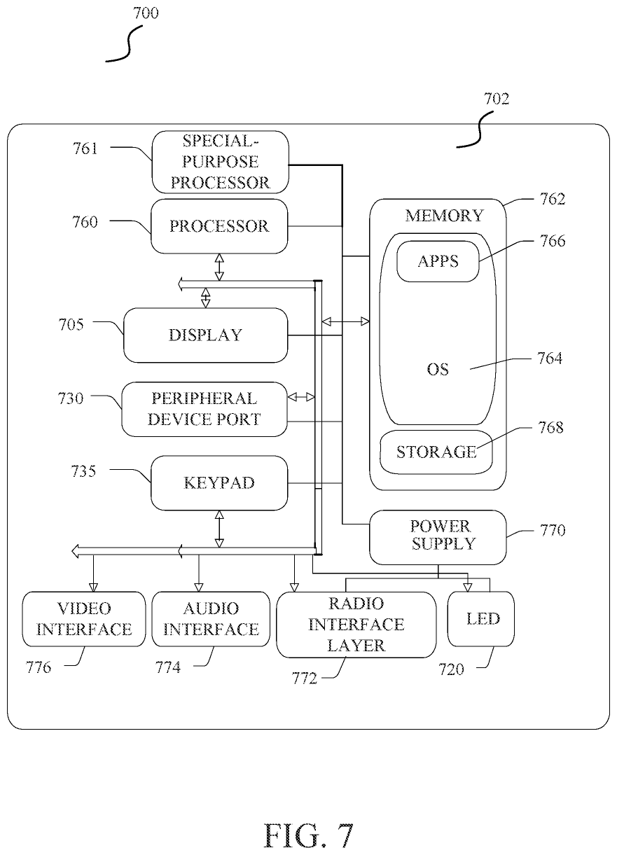

FIG. 7 illustrates a mobile computing device 700, for example, a mobile telephone, a smart phone, wearable computer (such as a smart watch, smart glasses, smart headphones, or the like), a tablet computer, a laptop computer, and the like, with which aspects of the disclosure may be practiced. In some aspects, the client may be a mobile computing device.

FIG. 7 is a block diagram illustrating the architecture of one aspect of a mobile computing device. That is, the mobile computing device 700 can incorporate a system (e.g., an architecture) 702 to implement some aspects. In one example, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated examples, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

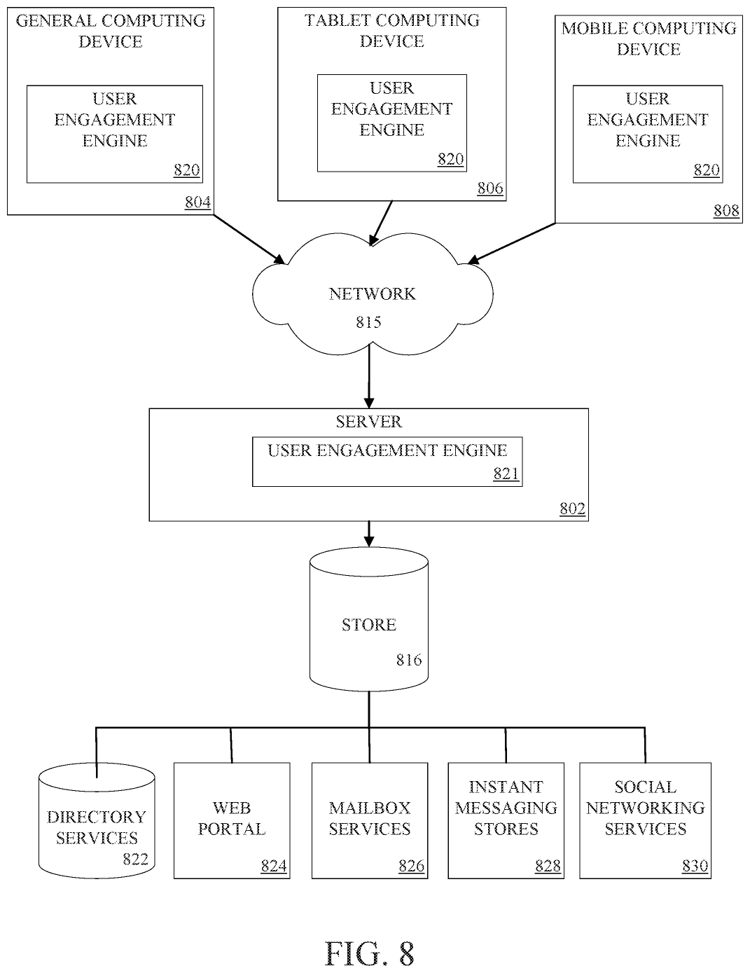

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking site 830.

A user engagement engine 820 may be employed by a client that communicates with server device 802, and/or multimodal machine learning engine 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

As will be understood from the foregoing disclosure, one aspect of the technology relates to a system comprising: at least one processor; and memory storing instructions that, when executed by the at least one processor, causes the system to perform a set of operations. The set of operations comprises: determining application features; generating a user group based on a similarity score of application features; generating a set of feature vectors for users in the user group; generating an engagement model; providing the feature vector to the engagement model; generating, by the engagement model a prediction; and providing the prediction to the reengagement model. In an example, a feature comprises one or more of available settings, application interface, accessibility features, search functionality, available application actions, different user account types with variable in-application user actions, external engagement options and in-application monetary options temporal features, location features, demographic features, user device settings, screen engagement, first user experience, subsequent user experience, tutorial engagement, search activity, application state, retention features, and external engagement. In another example, a similarity score comprises a measure of feature similarity between users within a group as well as with users outside the group. In yet another example, a user group is a categorization of users to recognize similar features among the users. In a further example, a prediction comprises a set of instructions with a high probability of maintaining user engagement and reengaging the user with the application for users within a user group. In a yet further example, the reengagement model is a machine learning model which generates prompt to an application with a high probability of maintaining user engagement and reengaging the user with the application for users within a user group. In a still further example, the engagement model is trained using supervised or unsupervised machine learning. In a further example the engagement model is trained using one or more of: the feature vector, user groups, features, prompt outcomes, or the engagement cycle. In another example, the engagement model is a machine learning model which generates predictions with a high probability of maintaining user engagement and reengaging the user with the application for users within a user group.

In a further aspect, the technology relates to a method comprising: categorizing a user into a user group associated with an engagement model; generating a prediction that the user will not continue engagement with an application, wherein the determination comprises: providing a feature vector to the engagement model; and receiving the prediction from the engagement model in response to providing the feature vector; determining a user is engaged in-application; generating, by a reengagement model, an in-application prompt for the user; and engaging the user with the in-application prompt. In an example, the method further comprises: returning a user response to the in-application prompt; and training the reengagement model with the user response to the in-application prompt. In a further example, an engagement model is a machine learning model which generates predictions with a high probability of maintaining user engagement and reengaging the user with the application for users within a user group. In another example, an in-application prompt comprises a signal from the reengagement model of a proactive action to alter user behavior with a high probability of maintaining user engagement with the application. In yet another example, engaging the user with the in-application prompt further comprises transmitting to the user a notification, pop-up display box on the display of the user device, a link, button, tag and other selectable option to facilitate the user choosing to engage, ignore, deny and disregard the prompt. In still another example determining a user is engaged in-application further comprises determining if the user is actively engaged with a feature on the application and if the application is open but in a background state on the device.

Another aspect of the technology relates to a method comprising: categorizing a user into a user group associated with an engagement model; generating a prediction that the user will not continue engagement with an application, wherein the determination comprises: providing a feature vector to the engagement model; and receiving the prediction from the engagement model in response to providing the feature vector; determining a user is not engaged in-application; generating, by a reengagement model, a prompt to reinitiate user engagement with the application; and engaging the user with the prompt. In an example, the method further comprises: returning a user response to the prompt; and training the reengagement model with the user response to the prompt. In another example, a prompt comprises a signal from the reengagement model of a proactive action to alter user behavior with a high probability of initiating user engagement with the application. In yet a further example, engaging the user with a prompt further comprises transmitting to the user a notification, pop-up display box on the display of the user device, a link, button, tag, email, text and other selectable option to facilitate the user choosing to engage, ignore, deny and disregard the prompt. In still a further example, determining a user is not engaged in-application further comprises determining if the user is not actively engaged with a feature on the application and if the application is not open on the device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
determining application features;
generating a user group based on a similarity score of application features;
generating a set of feature vectors for users in the user group;
generating an engagement model;
providing the feature vector to the engagement model;
generating, by the engagement model a prediction; and
providing the prediction to the reengagement model.

2. The system of claim 1, wherein features comprise one or more of: available settings, application interface, accessibility features, search functionality, available application actions, different user account types with variable in-application user actions, external engagement options and in-application monetary options temporal features, location features, demographic features, user device settings, screen engagement, first user experience, subsequent user experience, tutorial engagement, search activity, application state, retention features, and external engagement.

3. The system of claim 1, wherein a similarity score comprises a measure of feature similarity between users within a group as well as with users outside the group.

4. The system of claim 1, wherein a user group is a categorization of users to recognize similar features among the users.

5. The system of claim 1, wherein a prediction comprises a set of instructions with a high probability of maintaining user engagement and reengaging the user with the application for users within a user group.

6. The system of claim 1, wherein the reengagement model is a machine learning model which generates a prompt to an application with a high probability of maintaining user engagement and reengaging the user with the application for users within a user group.

7. The system of claim 1, wherein the engagement model is trained using supervised or unsupervised machine learning.

8. The system of claim 1, wherein engagement model is trained using one or more of:
the feature vector, user groups, features, prompt outcomes, or the engagement cycle.

9. The system of claim 1, wherein the engagement model is a machine learning model which generates predictions with a high probability of maintaining user engagement and reengaging the user with the application for users within a user group.

10. A method comprising:
categorizing a user into a user group associated with an engagement model;
generating a prediction that the user will not continue engagement with an application, wherein the determination comprises:
providing a feature vector to the engagement model; and
receiving the prediction from the engagement model in response to providing the feature vector;
determining a user is engaged in-application;
generating, by a reengagement model, an in-application prompt for the user; and
engaging the user with the in-application prompt.

11. The method of claim 10, further comprising:
returning a user response to the in-application prompt; and
training the reengagement model with the user response to the in-application prompt.

12. The method of claim 10, wherein an engagement model is a machine learning model which generates predictions with a high probability of maintaining user engagement and reengaging the user with the application for users within a user group.

13. The method of claim 10, wherein an in-application prompt comprises a signal from the reengagement model of a proactive action to alter user behavior with a high probability of maintaining user engagement with the application.

14. The method of claim 10, wherein engaging the user with the in-application prompt further comprises transmitting to the user a notification, pop-up display box on the display of the user device, a link, button, tag and other selectable option to facilitate the user choosing to engage, ignore, deny and disregard the prompt.

15. The method of claim 10, wherein determining a user is engaged in-application further comprises determining if the user is actively engaged with a feature on the application and if the application is open but in a background state on the device.

16. A method comprising:
categorizing a user into a user group associated with an engagement model;
generating a prediction that the user will not continue engagement with an application, wherein the determination comprises:
providing a feature vector to the engagement model; and
receiving the prediction from the engagement model in response to providing the feature vector;
determining a user is not engaged in-application;
generating, by a reengagement model, a prompt to reinitiate user engagement with the application; and
engaging the user with the prompt.

17. The method of claim 16, further comprising:
returning a user response to the prompt; and
training the reengagement model with the user response to the prompt.

18. The method of claim 16, wherein a prompt comprises a signal from the reengagement model of a proactive action to alter user behavior with a high probability of initiating user engagement with the application.

19. The method of claim 16, wherein engaging the user with a prompt further comprises transmitting to the user a notification, pop-up display box on the display of the user device, a link, button, tag, email, text and other selectable option to facilitate the user choosing to engage, ignore, deny and disregard the prompt.

20. The method of claim 16, wherein determining a user is not engaged in-application further comprises determining if the user is not actively engaged with a feature on the application and if the application is not open on the device.
